(19) United States
(12) Patent Application Publication
(10) Pub. No.: US 2026/0031412 A1
(43) Pub. Date: Jan. 29, 2026

(54) LITHIUM-ION BATTERY ELECTROLYTE

(71) Applicant: FORD GLOBAL TECHNOLOGIES, LLC, Dearborn, MI (US)

(72) Inventors: Keonseok OH, Novi, MI (US); Gunho KWAK, Novi, MI (US); Sangil HAN, Northville, MI (US); Liyuan SUN, Ann Arbor, MI (US); Chi PAIK, Grosse Ile, MI (US)

(21) Appl. No.: 18/780,983

(22) Filed: Jul. 23, 2024

(51) Int. Cl. H01M 10/42; H01M 4/02; H01M 4/131; H01M 4/66; H01M 10/0525; H01M 10/0567; H01M 10/0569

(52) U.S. Cl. CPC H01M 10/4235; H01M 4/131; H01M 4/661; H01M 10/0525; H01M 10/0567; H01M 10/0569; H01M 2004/028; H01M 2300/0037

(57) ABSTRACT

An electrode is presented. The electrode has a current collector and a positive active material layer deposited on it. The electrode includes an electrolyte. The electrolyte composition includes 1M lithium hexafluorophosphate and 0.5 wt. % vinylene carbonate, dissolved in a solvent mixture of ethylene carbonate and ethyl methyl carbonate in a 25/75 volume ratio. This electrolyte permeates the surface of the positive active material layer, effectively suppressing electrochemical oxidation during the electrochemical cycling process, thus increasing the stability and performance of the electrode assembly.

### TECHNICAL FIELD

The disclosure relates to electrolyte materials for lithium-ion batteries.

### BACKGROUND

Layered transition metal oxides are used as cathode materials due to their high energy density and good cycling stability. These materials have a combination of transition metals such as nickel, cobalt, and manganese, along with lithium ions that intercalate between the layers during the charge and discharge processes. However, increasing the nickel content in layered transition metal oxide cathodes can lead to structural instability, particularly during extended cycling or exposure to elevated temperatures. This instability may influence the battery's performance.

### SUMMARY

In one aspect of the disclosure, an electrode assembly is presented. The electrode assembly includes a current collector, a positive active material layer on the current collector; and an electrolyte, including 1M lithium hexafluorophosphate with a 0.5 wt. % vinylene carbonate dissolved in a solvent of ethylene carbonate and ethyl methyl carbonate in a 25/75 volume ratio, permeating a surface of the positive active material layer and configured to suppress electrochemical oxidation of the positive active material layer during electrochemical cycling of the positive active material layer. The current collector may be aluminum. The electrolyte may further include 0.5 wt. % propylene sulfone. The electrolyte may also further include 0.3 wt. % 1,3-propene sultone. The positive active material layer may be a lithium nickel manganese cobalt oxide. The electrolyte may further include 0.5 wt. % ethylene sulfate. The electrolyte may further include 1 wt. % fluoroethylene carbonate. The electrolyte may further include 1 wt. % lithium difluoro phosphate.

In another aspect of the disclosure, a battery cell is presented. The battery cell includes a negative electrode, a positive electrode, and an electrolyte, including lithium hexafluorophosphate and 0.5 wt. % vinylene carbonate dissolved in a solvent of ethylene carbonate and ethyl methyl carbonate, saturating the negative and positive electrodes such that disassociated lithium ions from the lithium hexafluorophosphate are stabilized by complexation with molecules of the vinylene carbonate to mitigate electrochemical oxidation of the positive electrode. The electrolyte of the battery cell may further include 1M of lithium hexafluorophosphate and 0.3M of lithium bis(fluorosulfonyl)imide. The solvent of the battery cell may include ethylene carbonate, ethyl methyl carbonate, and diethyl carbonate in a 25/45/30 volume ratio. The electrolyte of the battery cell may further include 0.5 wt. % propylene sulfone. In other configurations, the electrolyte of the battery cell may further include 0.3 wt. % 1,3-propene sultone. In further configurations, the electrolyte of the battery cell includes 0.5 wt. % ethylene sulfate. In other configurations, the electrolyte of the battery cell further includes 1 wt. % lithium difluoro phosphate. A capacity retention of the battery cell after 200 charge-discharge cycles may be greater than 80%.

In yet another aspect of the disclosure, a battery cell is presented. The battery cell includes a negative electrode, a positive electrode, and an electrolyte, including 1M lithium hexafluorophosphate with a 1 wt. % of fluoroethylene carbonate and a 0.5 wt. % vinylene carbonate dissolved in a solvent of ethylene carbonate, ethyl methyl carbonate, and diethyl carbonate in a 25/45/30 volume ratio, saturating the negative and positive electrodes such that lithium ions liberated from the lithium hexafluorophosphate are stabilized by solvation with molecules of the vinylene carbonate resulting in a direct current impedance of the battery cell, for a given state of charge, being less than a direct current impedance of an otherwise same battery cell without the vinylene carbonate. A direct current impedance of the battery cell may be at least 10% less than the direct current impedance of the otherwise same battery cell without the vinylene carbonate. The electrolyte of the battery cell may further include 0.5 wt. % propylene sulfone and 0.3 wt. % 1,3-propene sultone. In other configurations, the electrolyte of the battery cell further includes 0.5 wt. % ethylene sulfate and 1 wt. % lithium difluoro phosphate.

### BRIEF DESCRIPTION OF THE DRAWINGS

FIG. 1 is a table of test methods and descriptions;

FIG. 2 is a table of electrolyte samples and their compositions according to one or more aspects of the disclosure;

FIG. 3 is a table of solvent properties according to one or more aspects of the disclosure;

FIG. 4 is a table of performance characteristics of electrolyte samples according to one or more aspects of the disclosure;

FIG. 5 is a table of performance characteristics of electrolyte samples according to one or more aspects of the disclosure;

FIG. 6 is a graph of retention properties of electrolyte samples according to one or more aspects of the disclosure;

FIG. 7 shows a graph of swelling properties of electrolyte samples according to one or more aspects of the disclosure;

FIG. 8 is a graph of direct current internal resistance properties of electrolyte samples according to one or more aspects of the disclosure;

FIG. 9 is a graph of charge retention properties of electrolyte samples according to one or more aspects of the disclosure;

FIG. 10 is a graph of discharge retention properties of electrolyte samples according to one or more aspects of the disclosure;

FIG. 11 is a graph of swelling rate properties of electrolyte samples according to one or more aspects of the disclosure;

FIG. 12 is a graph of direct current internal resistance properties at a given state of charge for electrolyte samples according to one or more aspects of the disclosure;

FIG. 13 is a table of performance characteristics of electrolyte samples according to one or more aspects of the disclosure;

FIG. 14 is a graph of charge rate properties for electrolyte samples according to one or more aspects of the disclosure;

FIG. 15 is a graph of discharge rate properties for electrolyte samples according to one or more aspects of the disclosure;

FIG. 16 is a graph of retention properties for electrolyte samples according to one or more aspects of the disclosure;

FIG. 17 is a graph of swelling properties for electrolyte samples according to one or more aspects of the disclosure;

FIG. 18 is a graph of direct current internal resistance properties at a given state of charge for electrolyte samples according to one or more aspects of the disclosure;

FIG. 19 is a table of performance characteristics of electrolyte samples according to one or more aspects of the disclosure;

FIG. 20 is a graph of retention properties for electrolyte samples according to one or more aspects of the disclosure;

FIG. 21 is a graph of swelling properties for electrolyte samples according to one or more aspects of the disclosure;

FIG. 22 is a graph of direct current internal resistance properties at a given state of charge for electrolyte samples according to one or more aspects of the disclosure;

FIG. 23 is a table of performance characteristics of electrolyte samples according to one or more aspects of the disclosure;

FIG. 24 is a graph of storage retention properties at a given temperature for electrolyte samples according to one or more aspects of the disclosure;

FIG. 25 is a table of retention properties of electrolyte samples according to one or more aspects of the disclosure;

FIG. 26 is a graph of storage recovery capacity at a given temperature for electrolyte samples according to one or more aspects of the disclosure;

FIG. 27 is a table of recovery properties of electrolyte samples according to one or more aspects of the disclosure;

FIG. 28 is a graph of storage thickness change at a given temperature for electrolyte samples according to one or more aspects of the disclosure;

FIG. 29 is a table of thickness properties of electrolyte samples according to one or more aspects of the disclosure;

FIG. 30 is a graph of direct current internal resistance increase at a given temperature for electrolyte samples according to one or more aspects of the disclosure;

FIG. 31 is a table of thickness properties of electrolyte samples according to one or more aspects of the disclosure; and

FIG. 32 is a schematic diagram of a battery with an electrolyte according to one or more aspects of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when the liquid electrolyte is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

High nickel layered oxide batteries, particularly those using nickel manganese cobalt and nickel cobalt aluminum chemistries, are being considered for lithium-ion battery technology. These batteries are high in energy density, cycle life, and performance characteristics.

The high nickel content in these batteries, often greater than 60%, increases the energy density. This is because nickel contributes to a higher capacity by enabling more lithium ions to be intercalated into the cathode structure during charging. However, increasing the nickel content also introduces challenges. Nickel-rich cathodes tend to be more reactive, especially at high voltages.

The electrolyte in high nickel layered oxide batteries plays a role in the battery's performance. Electrolytes may consist of a lithium salt, such as LiPF₆, dissolved in a mixture of organic solvents such as ethylene carbonate and ethyl methyl carbonate. This combination in certain circumstances provides a balance of ionic conductivity and electrochemical stability.

An issue with high-voltage operation is the decomposition of the electrolyte, which can lead to formation of a resistive layer on an electrode surface, known as the solid electrolyte interphase. This layer can impede lithium-ion movement, reducing the battery's performance characteristics. To mitigate this, additives like fluoroethylene carbonate and vinylene carbonate may be included, which form more stable solid electrolyte interphase layers.

High nickel content lithium nickel cobalt manganese oxide refers to transition metal oxides with a layered structure and a nickel content of 80% or higher. Nickel, cobalt, and manganese are cathode materials in batteries. Increasing the nickel content in high nickel content lithium nickel cobalt manganese doubles the amount of lithium entering the lithium layers, resulting in higher capacity.

High nickel-nickel manganese cobalt batteries offer high capacity without increasing the operating voltage, due to its rich lithium layered oxide structure. It also exhibits high electrical conductivity and minimal capacity loss at high charge/discharge rates (C-rates). Challenges include reduced reaction stability due to residual lithium and performance degradation. High nickel content nickel cobalt manganese has low thermal stability and high gas generation, affecting cycle life at room temperature and at elevated temperatures. Aspects of the present disclosure relate to increasing high nickel-nickel cobalt manganese battery performance through electrolyte composition.

The presented electrolyte composition plays a role in the performance of lithium-ion batteries. The electrolyte composition includes 1.0 molar (M) lithium hexafluorophosphate salt dissolved in a solvent mixture of ethylene carbonate, ethyl methyl carbonate, and diethyl carbonate in a 25/45/30 volume (v/v/v) ratio. The electrolyte also contains various additives, including 1 wt. % fluoroethylene carbonate, 0.5 wt. % vinylene carbonate, 0.5 wt. % propane sultone, 0.3 wt. % 1,3-propene sultone, 0.5 wt. % ethylene sulfite, and 1 wt. % lithium difluoro phosphate.

The solvents utilized contribute to the performance of the proposed electrolyte. Ethylene carbonate, a cyclic carbonate with a high dielectric constant, is used to increase the solubility of the lithium hexafluorophosphate salt. Linear carbonates, such as ethyl methyl carbonate and diethyl carbonate, are employed to increase ion conductivity by reducing the viscosity of the electrolyte. Diethyl carbonate exhibits suitable high-temperature performance due to its high boiling point. Lithium hexafluorophosphate is used as a salt in lithium-ion battery electrolytes due to its electrochemical properties. It offers suitable solubility and high ion conductivity in non-aqueous solvents, facilitates the formation of a stable passivation layer on the surface of the aluminum foil housing, and promotes the formation of a stable solid electrolyte interphase on an electrode surface in the presence of carbonate ester solvents.

The electrolyte also incorporates various additives to better battery performance and stability. Vinylene carbonate is added to promote the formation of a stable film on the anode surface, which improves ionic conductivity and prevents unwanted side reactions. Fluoroethylene carbonate is included to increase cycling performance and direct current internal resistance (DC-IR) properties while preventing oxidation of the electrolyte. 1,3-propane sultone is used to form a stable layer on a cathode surface, while 1,3-propene sultone helps suppress gas generation and increase high-temperature storage stability. Ethylene sulfite is incorporated for corrosion prevention and low-temperature performance. Lithium difluoro phosphate is added to reduce the viscosity of the electrolyte, thereby improving ion conductivity, increasing battery life at high voltages, and slowing down the decomposition rate of the electrolyte.

The combination of these selected solvents, salts, and additives in the electrolyte composition increase the performance and stability of high nickel-nickel manganese cobalt cathode materials in lithium-ion batteries. The electrolyte formulation addresses challenges such as ionic conductivity, solid electrolyte interphase formation, gas generation, and high-temperature stability, which assist in the successful implementation of high nickel-nickel manganese cobalt cathodes in advanced battery applications.

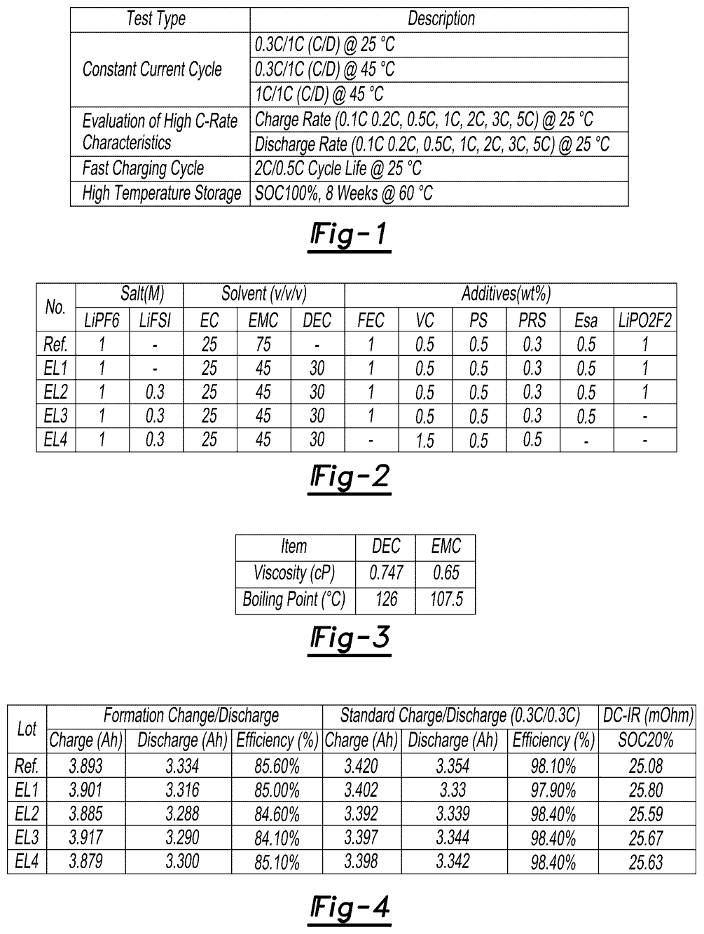

FIGS. 1-23 show compositions of electrolyte samples, their performance characteristics, and physical properties according to one or more aspects of the disclosure. FIG. 1 shows a table of test methods and their corresponding descriptions. The test types include Constant Current Cycle (C/C), Evaluation of High C-rate Characteristics, Fast Charging Cycle, and High Temperature Storage (HTS). For the C/C test, the description specifies cycling conditions at various temperatures: 0.3C/1C (C/D) at 25° C., 0.3C/1C (C/D) at 45° C., and 1C/1C (C/D) at 45° C. The Evaluation of High C-rate Characteristics test includes charge rates of 0.1C, 0.2C, 0.5C, 1C, 2C, 3C, and 5C at 25° C., and discharge rates of 0.1C, 0.2C, 0.5C, 1C, 2C, 3C, and 5C at 25° C. The Fast Charging Cycle test is performed at 2C/0.5C cycle life at 25° C. The HTS test involves storing the samples at SOC 100% for 8 weeks at 60° C. These test methods and conditions are used to evaluate the performance and characteristics of the electrolyte samples.

FIG. 2 is a table of electrolyte samples and their compositions according to one or more aspects of the disclosure. The reference sample includes 1M lithium hexafluorophosphate, ethylene carbonate/ethyl methyl carbonate (25/75 v/v), 1 weight percent fluoroethylene carbonate, 0.5 weight percent vinylene carbonate, 0.5 weight percent prop-1-ene-1,3-sultone, 0.3 weight percent propane sultone, 0.5 weight percent ethyl sulfite, and 1 weight percent lithium difluoro(oxalato)phosphate. The first electrolyte sample has a different solvent ratio of ethylene carbonate/ethyl methyl carbonate/diethyl carbonate (25/45/30 v/v/v). The second and third electrolyte samples introduce an additional salt, lithium bis(fluorosulfonyl)imide, at a concentration of 0.3M, while maintaining the same solvent ratio and additive concentrations as the first electrolyte sample, except for the exclusion of lithium difluoro(oxalato)phosphate in the third electrolyte sample. The fourth electrolyte sample also includes 0.3M lithium bis(fluorosulfonyl)imide but has a higher concentration of fluoroethylene carbonate at 1.5 weight percent and excludes the additives propane sultone, ethyl sulfite, and lithium difluoro(oxalato)phosphate.

FIG. 3 is a table of solvent properties for diethyl carbonate and ethyl methyl carbonate. Diethyl carbonate has a viscosity of 0.747 centipoise (cP) and a boiling point of 126° C. Ethyl methyl carbonate has a viscosity of 0.65 cP and a boiling point of 107.5° C.

FIG. 4 is a table of performance characteristics of electrolyte samples according to one or more aspects of the disclosure. The table includes data for the reference sample (Ref.) and four electrolyte samples (EL1, EL2, EL3, and EL4).

The table presents the formation charge/discharge values, standard charge/discharge values at 0.3C/0.3C rate, and the DC-IR measured in milliohms (mOhm) and state of charge (SOC) at 20%.

For the formation charge/discharge, the charge capacity (amp hours; Ah), discharge capacity (Ah), and efficiency (%) are provided. The reference sample shows a charge capacity of 3.893 Ah, a discharge capacity of 3.334 Ah, and an efficiency of 85.60%. The electrolyte samples EL1, EL2, EL3, and EL4 have similar charge capacities ranging from 3.879 Ah to 3.917 Ah, discharge capacities from 3.288 Ah to 3.316 Ah, and efficiencies between 84.10% and 85.10%.

For the standard charge/discharge at 0.3C/0.3C rate, the charge capacity (Ah), discharge capacity (Ah), and efficiency (%) are also provided. The reference sample has a charge capacity of 3.420 Ah, a discharge capacity of 3.354 Ah, and an efficiency of 98.10%. The electrolyte samples show charge capacities ranging from 3.388 Ah to 3.402 Ah, discharge capacities from 3.33 Ah to 3.344 Ah, and efficiencies between 97.90% and 98.40%.

The DC-IR measured in mOhm at a 20% SOC is also listed for each sample. The reference sample has a DC-IR of 25.08 mOhm, while the electrolyte samples have DC-IR values ranging from 25.59 mOhm to 25.80 mOhm.

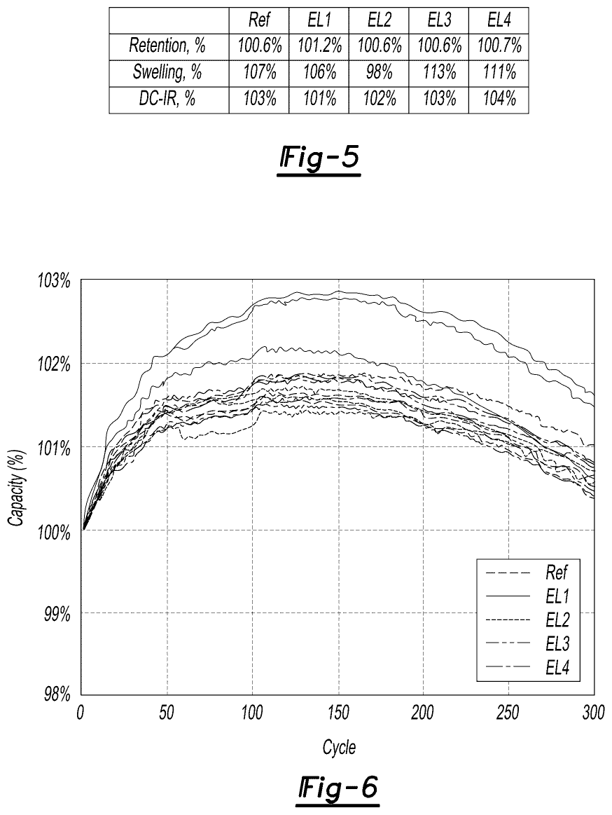

FIG. 5 is a table of performance characteristics for the reference sample (Ref.) and four electrolyte samples (EL1, EL2, EL3, and EL4) under a 25° C. cycle test at a 0.3C/1C rate. The table includes data on retention percentage, swelling percentage, and DC-IR percentage for each sample after the test. The reference sample exhibits 100.6% retention, 107% swelling, and 103% DC-IR. The electrolyte samples show retention percentages ranging from 100.6% to 101.2%, swelling percentages from 98% to 113%, and DC-IR percentages between 101% and 104%.

The 25° C. cycle test reveals several findings regarding the performance of the electrolyte samples. Firstly, EL1 and EL2 demonstrate reduced DC-IR increase and less swelling during RT cycles (@300cycles) compared to the reference sample. Secondly, even under a 25° C. cycle, all samples exhibit a 3% increase in capacity retention until the 150^{th} cycle. Lastly, despite a 30% decrease in diethyl carbonate content, the electrolyte samples still show positive results in terms of the 25° C. cycle (0.3C/1C) performance and DC-IR. These findings highlight the improved performance characteristics of the electrolyte samples compared to the reference sample, particularly in terms of DC-IR, swelling, and capacity retention.

FIG. 6 is a graph showing the retention properties of the reference sample (Ref.) and four electrolyte samples (EL1, EL2, EL3, and EL4) over 300 cycles according to one or more aspects of the disclosure. The graph presents the capacity retention percentage on the y-axis and the cycle number on the x-axis.

The graph reveals that all samples exhibit an initial increase in capacity retention, reaching a peak at around the 50^{th} cycle. The reference sample shows the highest peak retention at approximately 102.5%, while the electrolyte samples have slightly lower peak retentions ranging from 101.5% to 102%. After the peak, all samples demonstrate a gradual decline in capacity retention over the remaining cycles.

EL1 and EL2 show the best overall retention performance, maintaining a higher capacity retention compared to the reference sample and the other electrolyte samples throughout the 300 cycles. EL3 and EL4 exhibit slightly lower retention than EL1 and EL2 but still outperform the reference sample. By the end of the 300 cycles, all electrolyte samples maintain a capacity retention above 99%, while the reference sample's retention drops below 99%.

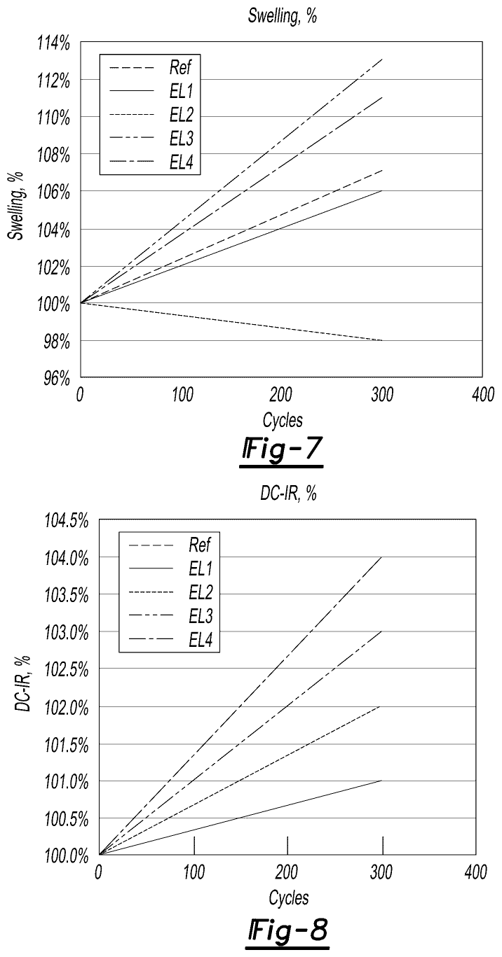

FIG. 7 presents a graph illustrating the swelling properties of the reference sample (Ref.) and four electrolyte samples (EL1, EL2, EL3, and EL4) over 400 cycles according to one or more aspects of the disclosure. The graph displays the swelling percentage on the y-axis and the number of cycles on the x-axis.

The graph shows that all samples experience an increase in swelling percentage as the number of cycles increases. However, the rate of swelling varies among the samples. The reference sample exhibits the highest swelling percentage, reaching approximately 113% by the end of the 400 cycles. In contrast, the electrolyte samples demonstrate better swelling resistance, with EL1 and EL2 showing the lowest swelling percentages of around 105% and 103%, respectively.

EL3 and EL4 also display improved swelling resistance compared to the reference sample, with swelling percentages of approximately 109% and 107%, respectively, by the 400th cycle. The graph highlights the superior swelling resistance of the electrolyte samples, particularly EL1 and EL2, which maintain significantly lower swelling percentages throughout the cycling process compared to the reference sample.

The improved swelling resistance of the electrolyte samples can be attributed to their optimized compositions, which likely contribute to better stability and reduced gas generation during extended cycling. The results suggest that the electrolyte formulations, especially those of EL1 and EL2, have the potential to enhance the performance and longevity of lithium-ion batteries by minimizing swelling-related issues.

FIG. 8 depicts a graph of the DC-IR properties of the reference sample (Ref.) and four electrolyte samples (EL1, EL2, EL3, and EL4) over 400 cycles according to one or more aspects of the disclosure. The graph presents the DC-IR percentage on the y-axis and the number of cycles on the x-axis.

The graph reveals that all samples experience an increase in DC-IR percentage as the number of cycles progresses. However, the electrolyte samples demonstrate better DC-IR performance compared to the reference sample. The reference sample shows the highest DC-IR percentage, reaching approximately 104.5% by the end of the 400 cycles. In contrast, EL1 and EL2 exhibit the lowest DC-IR percentages, maintaining values below 102% throughout the cycling process.

EL3 and EL4 also display improved DC-IR performance compared to the reference sample, with DC-IR percentages of around 103% and 102.5%, respectively, by the 400^{th} cycle. The graph highlights the superior DC-IR stability of the electrolyte samples, particularly EL1 and EL2, which maintain significantly lower DC-IR percentages throughout the cycling process compared to the reference sample.

The enhanced DC-IR stability of the electrolyte samples can be attributed to their optimized compositions, which likely contribute to reduced internal resistance growth and improved ionic conductivity during extended cycling. The results suggest that the electrolyte formulations, especially those of EL1 and EL2, have the potential to enhance the performance and efficiency of lithium-ion batteries by minimizing DC-IR-related losses and maintaining lower internal resistance over the battery's lifetime.

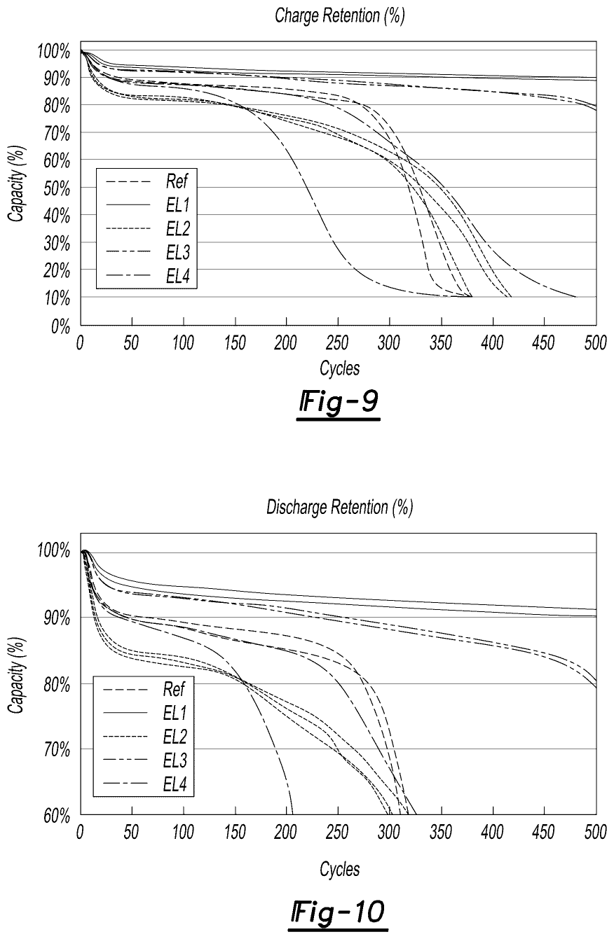

FIG. 9 is a graph depicting the charge retention properties of the reference sample (Ref.) and four electrolyte samples (EL1, EL2, EL3, and EL4) over 500 cycles according to one or more aspects of the disclosure. The graph presents the capacity retention percentage on the y-axis and the cycle number on the x-axis.

The graph reveals that all samples exhibit an initial increase in capacity retention, reaching a peak at around the 50^{th} cycle. After the peak, all samples demonstrate a gradual decline in capacity retention over the remaining cycles. EL1 and EL2 show the best overall retention performance, maintaining a higher capacity retention compared to the reference sample and the other electrolyte samples throughout the 500 cycles. EL3 and EL4 also outperform the reference sample, exhibiting slightly lower retention than EL1 and EL2.

By the end of the 500 cycles, EL1 and EL2 maintain a capacity retention above 90%, while the reference sample's retention drops to approximately 88%. EL3 and EL4 demonstrate a capacity retention of around 89% at the 500th cycle. The graph highlights the superior charge retention properties of the electrolyte samples, particularly EL1 and EL2, compared to the reference sample over extended cycling.

FIG. 10 is a graph showing the discharge retention properties of the reference sample (Ref.) and four electrolyte samples (EL1, EL2, EL3, and EL4) over 500 cycles according to one or more aspects of the disclosure. The graph presents the capacity retention percentage on the y-axis and the cycle number on the x-axis.

The graph reveals that all samples exhibit a gradual decline in discharge capacity retention as the number of cycles increases. However, the electrolyte samples demonstrate better discharge retention performance compared to the reference sample. EL1 and EL2 show the highest discharge retention percentages throughout the 500 cycles, maintaining values above 95% by the end of the cycling process.

EL3 and EL4 also display improved discharge retention compared to the reference sample, with retention percentages of approximately 93% and 94%, respectively, at the 500th cycle. In contrast, the reference sample exhibits the lowest discharge retention, dropping to around 91% by the end of the 500 cycles.

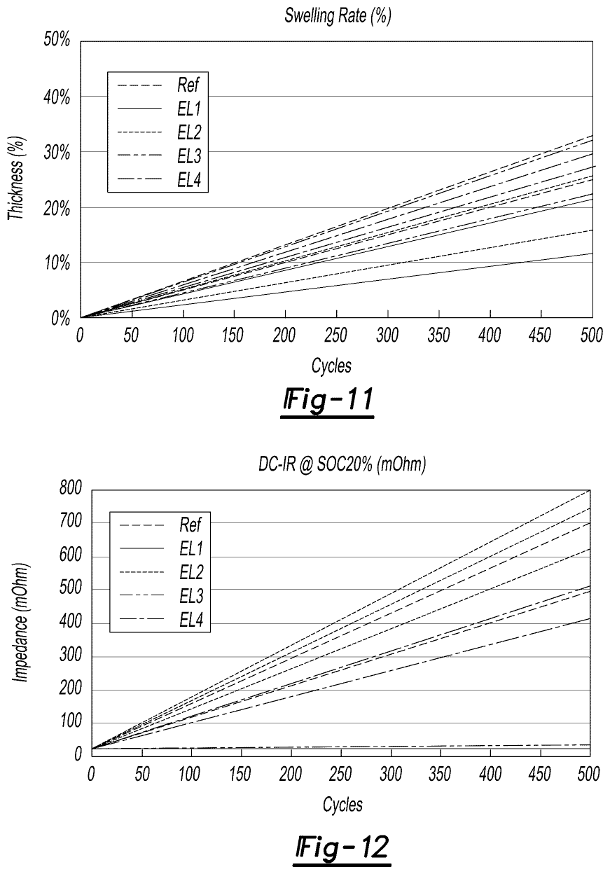

FIG. 11 is a graph depicting the swelling rate properties of the reference sample (Ref.) and four electrolyte samples (EL1, EL2, EL3, and EL4) over 500 cycles according to one or more aspects of the disclosure. The graph presents the thickness increase percentage on the y-axis and the cycle number on the x-axis.

The graph reveals that all samples experience an increase in swelling rate as the number of cycles progresses. However, the electrolyte samples demonstrate significantly lower swelling rates compared to the reference sample. The reference sample exhibits the highest swelling rate, reaching approximately 45% thickness increase by the end of the 500 cycles.

In contrast, EL2 shows the lowest swelling rate, maintaining a thickness increase below 15% throughout the cycling process. EL1, EL3, and EL4 also display improved swelling resistance compared to the reference sample, with swelling rates of around 20%, 25%, and 30%, respectively, at the 500th cycle.

The graph highlights the superior swelling resistance of the electrolyte samples, particularly EL2, which maintains a remarkably low swelling rate throughout the extended cycling process. This suggests that the optimized compositions of the electrolyte samples, especially that of EL2, contribute to enhanced dimensional stability and reduced gas generation during prolonged battery operation.

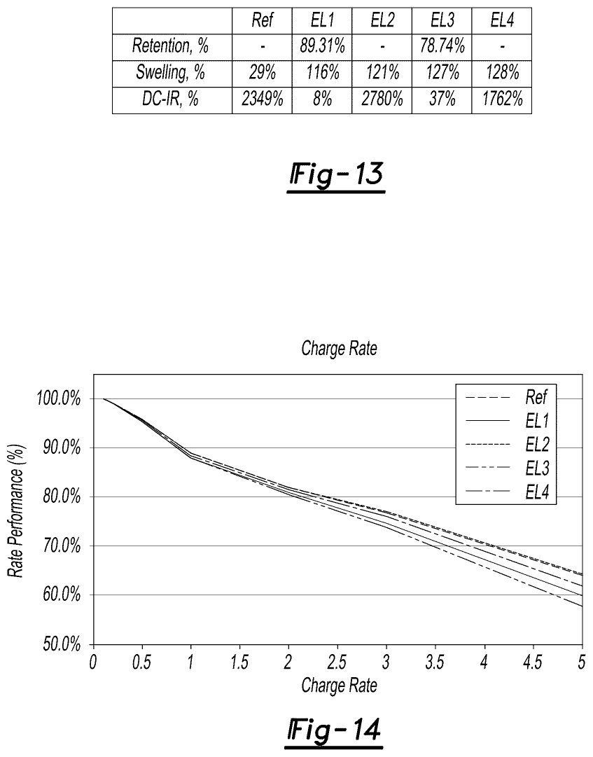

FIG. 12 is a graph of the DC-IR properties at a SOC of 20% for the reference sample (Ref.) and four electrolyte samples (EL1, EL2, EL3, and EL4) over 500 cycles according to one or more aspects of the disclosure. The graph presents the DC-IR values in mOhm on the y-axis and the cycle number on the x-axis.

The graph reveals that all samples experience an increase in DC-IR values as the number of cycles progresses. However, the electrolyte samples demonstrate significantly lower DC-IR growth compared to the reference sample. The reference sample exhibits the highest DC-IR values, reaching approximately 700 mOhm by the end of the 500 cycles.

In contrast, EL2 shows the lowest DC-IR growth, maintaining values below 200 mOhm throughout the cycling process. EL1, EL3, and EL4 also display improved DC-IR stability compared to the reference sample, with DC-IR values of around 300 mOhm, 400 mOhm, and 500 mOhm, respectively, at the 500th cycle.

FIG. 13 is a table of performance metrics between the reference electrolyte (Ref) and the four modified electrolyte formulations (EL1, EL2, EL3, EL4) after undergoing a 45° C. 1C/1C cycle test. This high temperature cycling test provides valuable insights into how the different electrolyte compositions hold up under more challenging conditions compared to the 25° C. tests discussed earlier in the specification.

In terms of retention %, EL1 shows the highest capacity retention at 89.31%, a significant improvement over the reference. EL3 is next best at 78.74%. Notably, no retention data is provided for EL2 and EL4. For swelling %, all four modified electrolytes exhibit reduced swelling compared to the reference's 29%. EL1 has the lowest swelling at 116%, followed closely by EL2 at 121%. EL3 and EL4 have slightly higher swelling at 127% and 128% respectively, but still much better than the reference.

DC-IR growth is lower for EL1 at only 8% compared to the very high 2349% increase seen in the reference electrolyte. EL3 has the next lowest DC-IR growth at 37%. Interestingly, EL2 shows substantially higher DC-IR growth at 2780%, even exceeding the reference, while EL4 is also high at 1762%.

FIGS. 14-15 are graphs of the charge and discharge rate performance, respectively, of the reference electrolyte (Ref) and the four modified electrolyte formulations (EL1, EL2, EL3, EL4) over a range of C-rates from 0.1C to 5.0C. These graphs provide valuable insights into how the different electrolyte compositions perform under varying current densities.

In FIG. 14, which focuses on the charge rate, the reference electrolyte exhibits higher charge capacity compared to the modified electrolytes at all C-rates tested. Among the modified formulations, EL2 stands out as having similar charge capacity to the reference at the higher C-rates of 3C and 5C. This suggests that the composition of EL2 may be particularly well-suited for fast charging applications.

FIG. 15 shows the discharge rate performance, and here EL1 demonstrates higher discharge capacities compared to the reference electrolyte across the range of discharge rates tested. This indicates that the modifications made in EL1 are beneficial for maintaining discharge capacity at elevated current densities.

The background information provided gives further context to these results. It is noted that performance remained consistent up to a 3C discharge rate, but a significant drop was observed starting from 1C during charging. This highlights the challenge of maintaining performance at high charging rates and suggests that C-rate control may be necessary during fast charging to mitigate capacity loss.

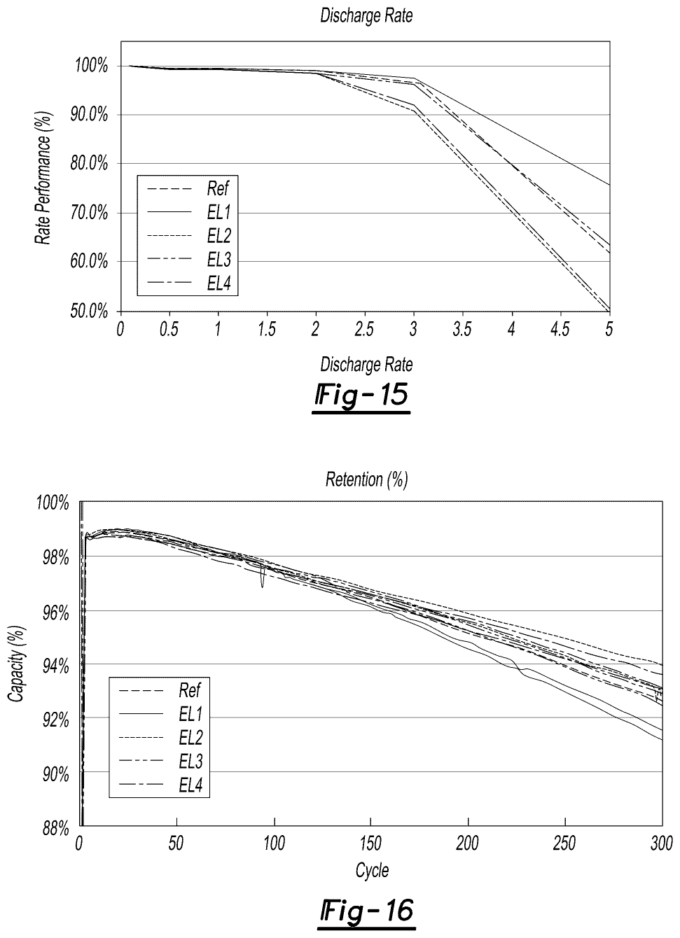

FIGS. 16-19 show results for a 45° C. cycling test performed at a 0.3C/1C charge/discharge rate for the reference electrolyte (Ref) and four modified electrolyte formulations (EL1, EL2, EL3, EL4).

FIG. 16 is a graph showing the capacity retention percentage over 300 cycles for the reference electrolyte (Ref) and four modified electrolyte formulations (EL1, EL2, EL3, EL4). The reference exhibits the lowest retention, dropping to about 88% by cycle 300. EL1 and EL2 demonstrate the highest retention, remaining above 90% at cycle 300. EL3 and EL4 also outperform the reference, with around 89% retention by the end of the cycling test.

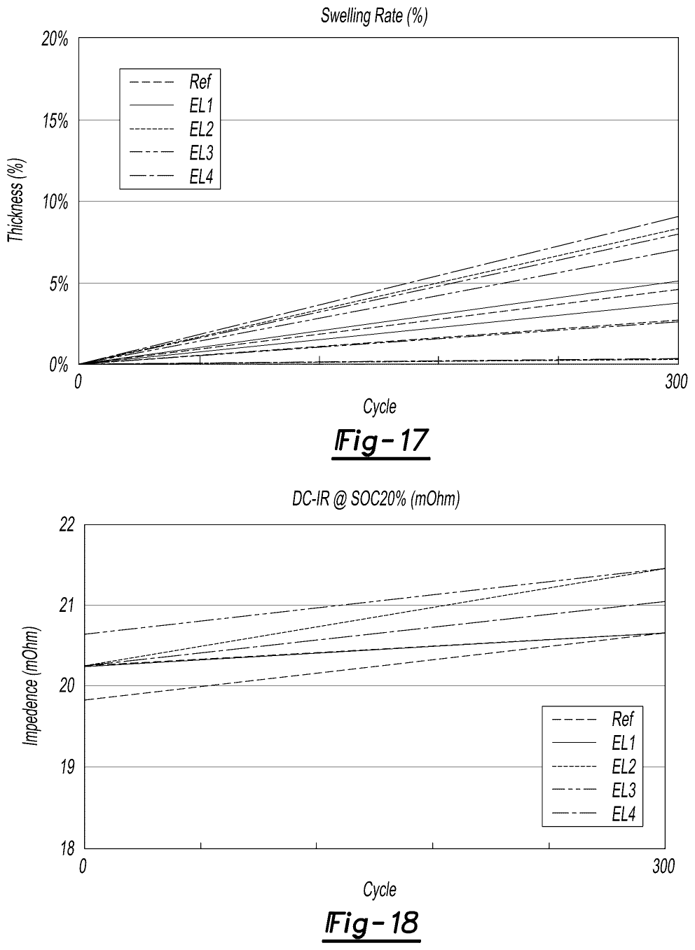

FIG. 17 is a graph showing the swelling rate percentage over 300 cycles. The reference electrolyte shows a steep increase in swelling, reaching approximately 18% by cycle 300. In contrast, the modified electrolytes have significantly improved swelling resistance. EL2 exhibits the lowest swelling rate, staying below 5% throughout the test. EL1, EL3 and EL4 also maintain low swelling rates of around 5-7% by cycle 300, demonstrating superior dimensional stability compared to the reference.

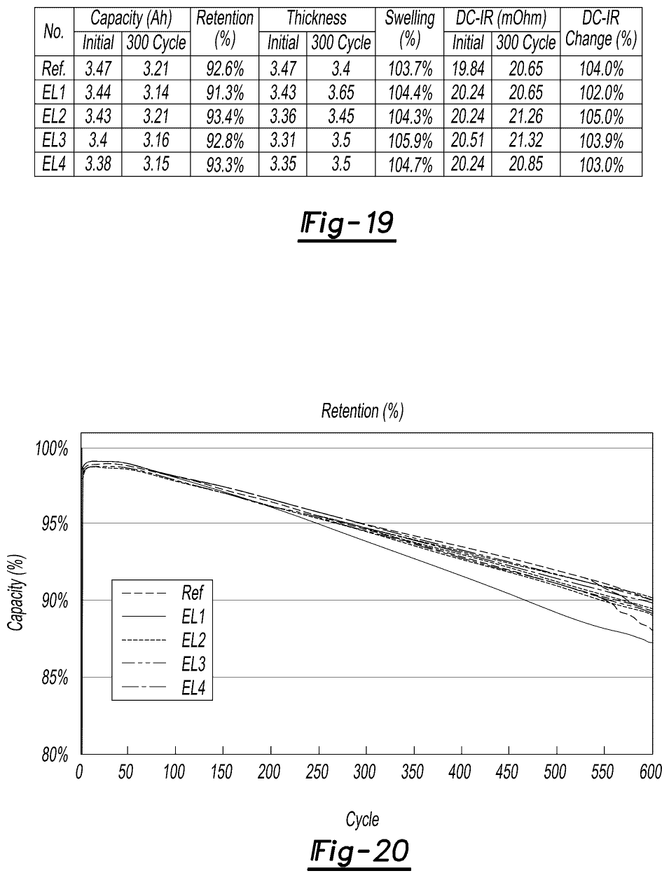

FIG. 18 is a graph showing the DC-IR measured in mOhm at a SOC of 20% over 300 cycles. The reference electrolyte has the highest DC-IR growth, increasing from about 19 mOhm initially to over 22 mOhm by cycle 300, a change of 104.1% as shown in FIG. 19. The modified electrolytes all exhibit lower DC-IR increase. EL1 has the smallest change of 102%, with a DC-IR of 20.65 mOhm at cycle 300. EL2, EL3 and EL4 have modest increases to 21.26, 21.32 and 20.85 mOhm respectively, corresponding to 103-105% of their initial values.

FIG. 19 is a table showing the results from the 300 cycle test, including capacity retention, thickness change, and DC-IR change percentages. For capacity retention, EL2 is highest at 93.4%, but shows slightly higher swelling of 104.3% and DC-IR increase of 105% compared to EL1. EL1 has the next best capacity retention of 91.3% while maintaining the lowest DC-IR increase at 102% and comparably low swelling of 104.4% relative to the other samples. Overall, EL1 and EL2 appear to provide the best balance of performance across the three measured parameters over extended cycling.

FIGS. 20-23 show results for a 45° C. cycling test performed at a 1C/1C charge/discharge rate for the reference electrolyte (Ref) and four modified electrolyte formulations (EL1, EL2, EL3, EL4).

FIG. 20 is a graph showing the capacity retention percentage over 600 cycles for the reference electrolyte (Ref) and four modified electrolyte formulations (EL1, EL2, EL3, EL4). The reference exhibits the lowest retention, dropping to about 88% by cycle 600. EL1 and EL2 demonstrate the highest retention, remaining above 90% at cycle 600. EL3 and EL4 also outperform the reference, with around 89% retention by the end of the cycling test.

FIG. 21 is a graph showing the swelling rate percentage over 600 cycles. The reference electrolyte shows a steep increase in swelling, reaching approximately 18% by cycle 600. In contrast, the modified electrolytes have significantly improved swelling resistance. EL2 exhibits the lowest swelling rate, staying below 5% throughout the test. EL1, EL3, and EL4 also maintain low swelling rates of around 5-7% by cycle 600, demonstrating superior dimensional stability compared to the reference.

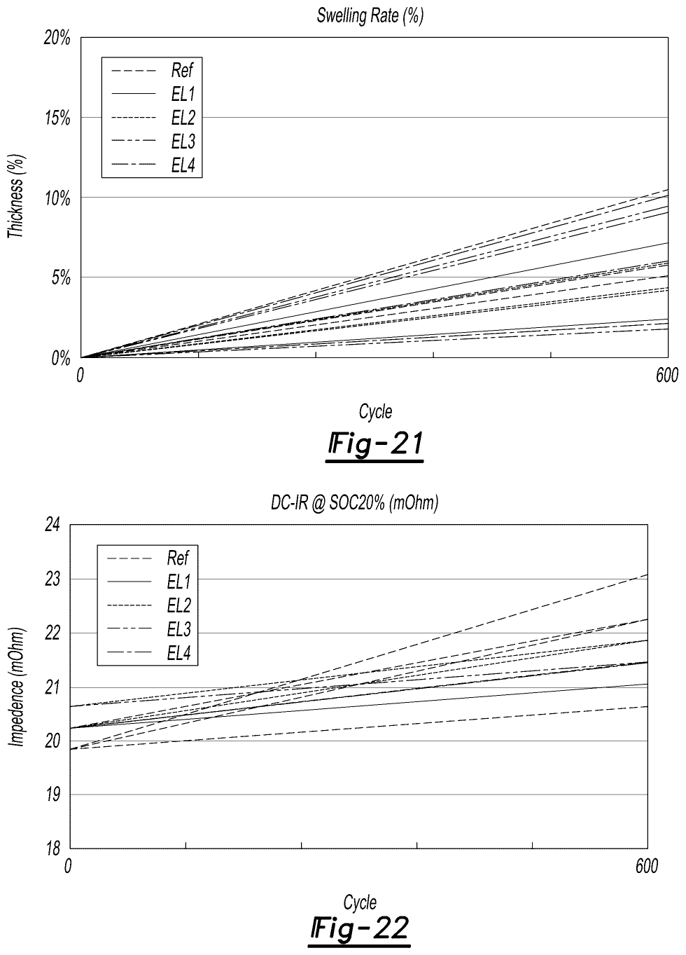

FIG. 22 is a graph showing the DC-IR measured in mOhm at a SOC of 20% over 600 cycles. The reference electrolyte has the highest DC-IR growth, increasing from about 19 mOhm initially to over 22 mOhm by cycle 600, a change of 104.1% as shown in FIG. 19. The modified electrolytes all exhibit lower DC-IR increase. EL1 has the smallest change of 102%, with a DC-IR of 20.65 mOhm at cycle 600. EL2, EL3, and EL4 have modest increases to 21.26, 21.32, and 20.85 mOhm respectively, corresponding to 103-105% of their initial values.

FIG. 23 is a table showing the results from the 600 cycle test, including capacity retention, thickness change, and DC-IR change percentages. For capacity retention, EL2 is highest at 93.4%, but shows slightly higher swelling of 104.3% and DC-IR increase of 105% compared to EL1. EL1 has the next best capacity retention of 91.3% while maintaining the lowest DC-IR increase at 102% and comparably low swelling of 104.4% relative to the other samples. Overall, EL1 and EL2 appear to provide the best balance of performance across the three measured parameters over extended cycling.

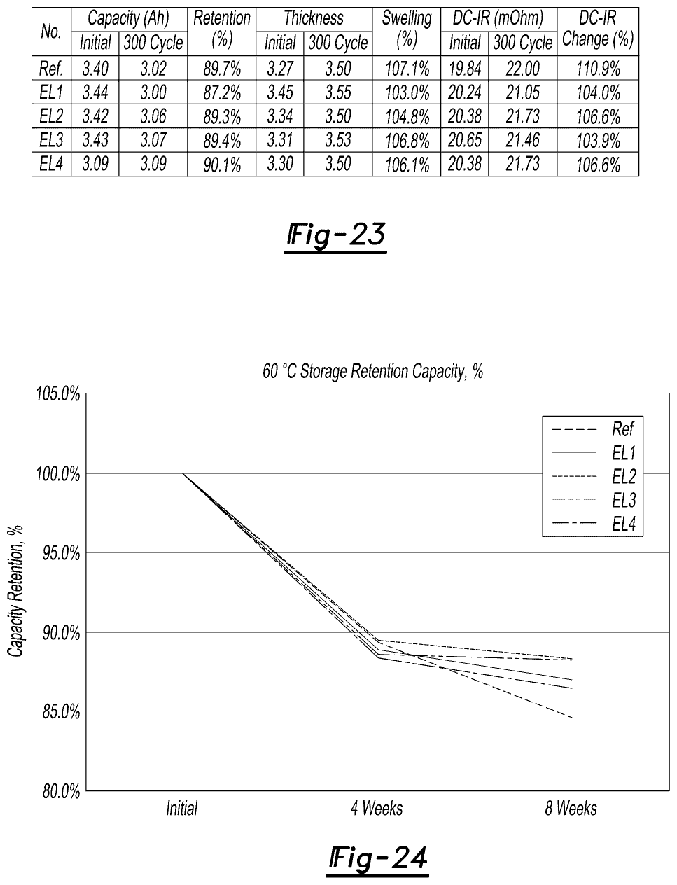

FIGS. 24-31 show results for a 60° C. storage test performed over an 8-week period for the reference electrolyte (Ref) and four modified electrolyte formulations (EL1, EL2, EL3, EL4).

FIG. 24 is a graph showing the capacity retention percentage over an 8-week period for the reference electrolyte (Ref) and four modified electrolyte formulations (EL1, EL2, EL3, EL4). The reference exhibits the lowest retention, dropping to about 84.6% by week 8. EL2 and EL3 demonstrate the highest retention, remaining above 88% at week 8. EL1 and EL4 also outperform the reference, with around 87% retention by the end of the storage period.

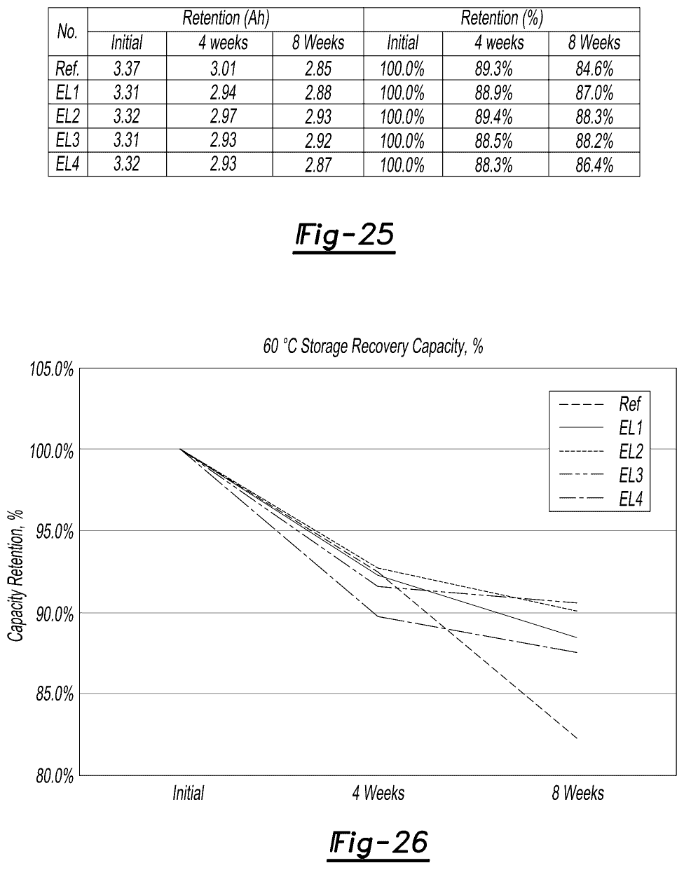

FIG. 25 is a table showing the capacity retention in Ah and percentage over the 8-week period. Initial capacity values are normalized to 100%. EL2 shows the highest retention percentage at week 8 with 88.3%, while the reference drops to 84.6%.

FIG. 26 is a graph showing the capacity recovery percentage over an 8-week period. The reference electrolyte shows the lowest recovery, decreasing to 82.4% by week 8. EL3 and EL2 demonstrate superior recovery percentages of around 90% by the end of the period. EL1 and EL4 also exhibit better recovery compared to the reference.

FIG. 27 is a table showing the capacity recovery in Ah and percentage over the 8-week period. Initial recovery values are normalized to 100%. EL3 shows the highest recovery percentage at week 8 with 90.5%, while the reference drops to 82.4%.

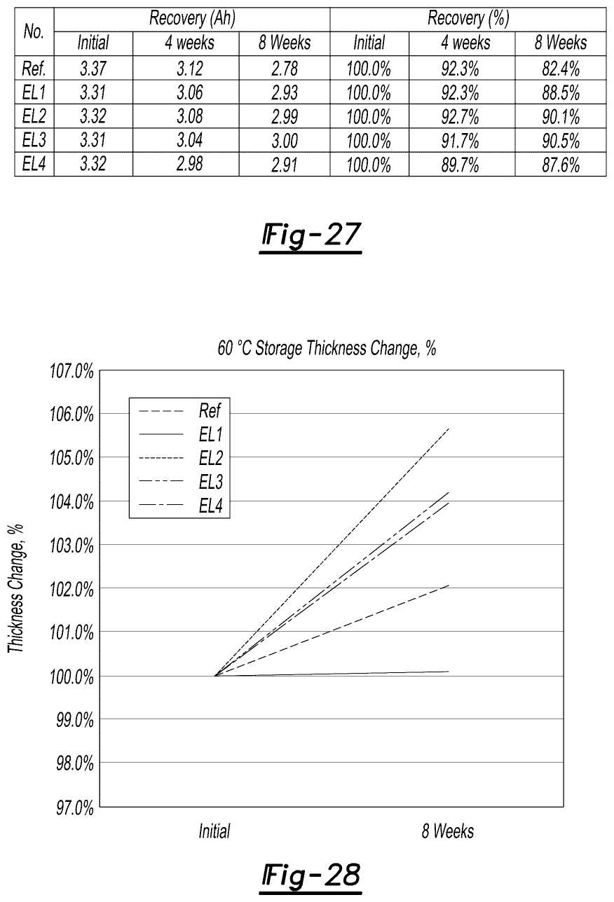

FIG. 28 is a graph showing the thickness change percentage over the 8-week period. EL2 shows the highest increase in thickness, reaching approximately 105.6% by week 8. EL1 demonstrates the most stable thickness, maintaining close to 100.1% throughout the storage period.

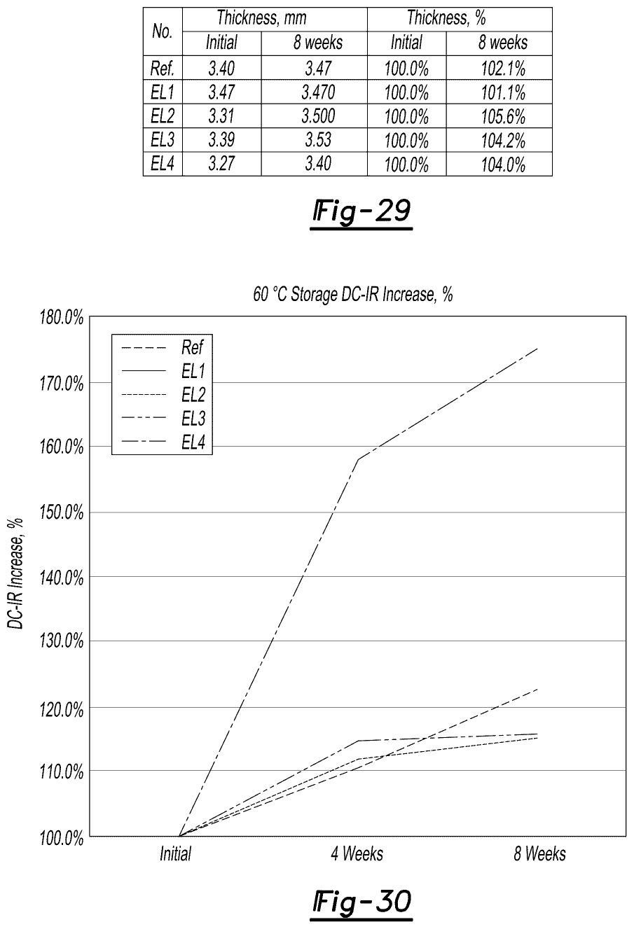

FIG. 29 is a table showing the thickness in millimeters (mm) and percentage change over the 8-week period. Initial thickness values are normalized to 100%. EL2 shows the highest thickness change at week 8 with 105.6%, while EL1 remains the most stable with 100.1%.

FIG. 30 is a graph showing the DC-IR increase percentage over the 8-week period. EL4 exhibits the highest increase in DC-IR, reaching approximately 175.3% by week 8. EL1 shows the most stable DC-IR values, maintaining close to 114.9% throughout the storage period.

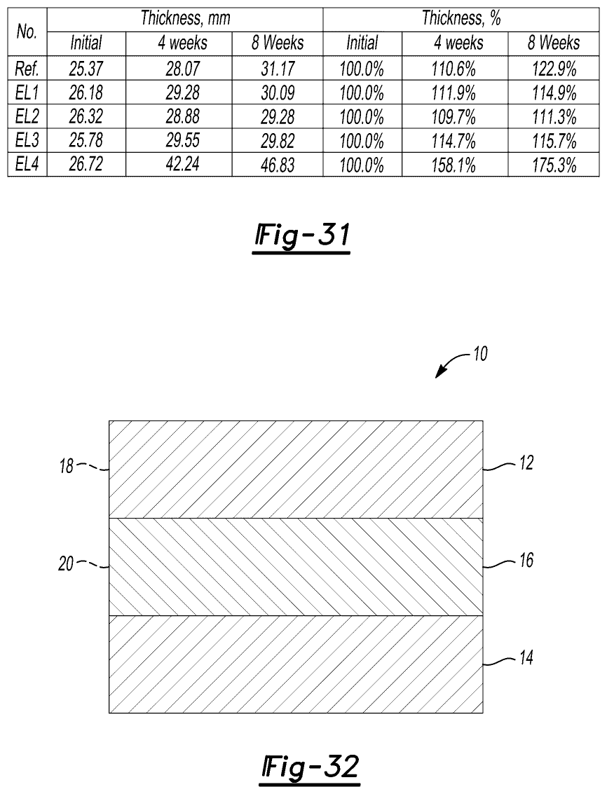

FIG. 31 is a table showing the DC-IR in mOhm and percentage increase over the 8-week period. Initial DC-IR values are normalized to 100%. EL4 shows the highest DC-IR increase at week 8 with 175.3%, while EL1 remains the most stable with 114.9%.

FIG. 32 shows a battery cell 10 with a positive electrode 12, a negative electrode 14, and a current collector 16. The positive electrode 12 contains a positive active material 18 that forms a layer of the positive electrode 12. The battery cell 10 contains a liquid electrolyte 20. The liquid electrolyte 20 permeates the surface of the positive active material layer and includes 1M lithium hexafluorophosphate with 0.5 wt. % vinylene carbonate dissolved in a solvent of ethylene carbonate and ethyl methyl carbonate in a 25/75 volume ratio. This specific composition of the liquid electrolyte 20 is configured to suppress electrochemical oxidation of the positive active material layer 18 during electrochemical cycling. The liquid electrolyte 20 may also include various additives to enhance the battery's performance. For instance, the liquid electrolyte 20 may further include 0.5 wt. % propylene sulfone to increase high-temperature performance and cycling stability, or 0.3 wt. % 1,3-propene sultone to fortify formation of a stable solid electrolyte interphase on the electrode surfaces, thereby reducing impedance and improving cycle life. Additionally, 0.5 wt. % ethylene sulfate can be added to stabilize the liquid electrolyte 20 further and suppress side reactions that could degrade the performance of battery cell 10 over time. Including 1 wt. % fluoroethylene carbonate provides additional stabilization of a solid electrolyte interphase layer and improves the overall performance and stability of the battery cell 10. Moreover, 1 wt. % lithium difluoro phosphate may be included to increase the thermal stability and ionic conductivity of the liquid electrolyte 20, contributing to improved battery performance under various operating conditions. The liquid electrolyte 20 saturates the positive electrode 12 and the negative electrode 14 such that disassociated lithium ions from the lithium hexafluorophosphate are stabilized by solvation with molecules of the vinylene carbonate to mitigate electrochemical oxidation of the positive electrode 12, thereby resulting in a DC-IR of the battery cell 10, for a given state of charge, being less than a DC-IR of an otherwise same battery cell without the vinylene carbonate.

In another embodiment, the liquid electrolyte 20 includes 1M lithium hexafluorophosphate and 0.3M lithium bis(fluorosulfonyl)imide dissolved in a solvent mixture of ethylene carbonate and ethyl methyl carbonate in a 25/75 volume ratio, which saturates the positive electrode 12 and the negative electrode 14. The lithium ions from the lithium hexafluorophosphate may be stabilized by complexation with molecules of vinylene carbonate to mitigate electrochemical oxidation of the positive electrode 12. In yet another embodiment, the solvent mixture includes ethylene carbonate, ethyl methyl carbonate, and diethyl carbonate in a 25/45/30 volume ratio to provide a balance between high ionic conductivity and stability, increasing performance of the battery cell 10 and cycle life. The current collector 16 may be made of aluminum, which provides conductivity and stability in the battery 10. The positive active material layer 18 may be composed of lithium nickel manganese cobalt oxide, which offers high capacity and thermal stability, contributing to the overall performance and stability of the battery cell 10. Moreover, the battery cell 10 is configured to retain its capacity over a prolonged period, with a capacity retention of the battery cell 10 after 200 charge-discharge cycles being greater than 80%.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrode assembly comprising:
a current collector;
a positive active material layer on the current collector; and
an electrolyte, including 1M lithium hexafluorophosphate with a 0.5 wt. % vinylene carbonate dissolved in a solvent of ethylene carbonate and ethyl methyl carbonate in a 25/75 volume ratio, permeating a surface of the positive active material layer and configured to suppress electrochemical oxidation of the positive active material layer during electrochemical cycling of the positive active material layer.

2. The electrode assembly of claim 1 wherein the current collector is aluminum.

3. The electrode assembly of claim 1 wherein the electrolyte further includes 0.5 wt. % propylene sulfone.

4. The electrode assembly of claim 1 wherein the electrolyte further includes 0.3 wt. % 1,3-propene sultone.

5. The electrode assembly of claim 1 wherein the positive active material layer is a lithium nickel manganese cobalt oxide.

6. The electrode assembly of claim 1 wherein the electrolyte further includes 0.5 wt. % ethylene sulfate.

7. The electrode assembly of claim 1 wherein the electrolyte further includes 1 wt. % fluoroethylene carbonate.

8. The electrode assembly of claim 1 wherein the electrolyte further includes 1 wt. % lithium difluoro phosphate.

9. A battery cell comprising:
a negative electrode;
a positive electrode; and
an electrolyte, including lithium hexafluorophosphate and 0.5 wt. % vinylene carbonate dissolved in a solvent of ethylene carbonate and ethyl methyl carbonate, saturating the negative and positive electrodes such that disassociated lithium ions from the lithium hexafluorophosphate are stabilized by complexation with molecules of the vinylene carbonate to mitigate electrochemical oxidation of the positive electrode.

10. The battery cell of claim 9 wherein the electrolyte further includes 1M of lithium hexafluorophosphate and 0.3M of lithium bis(fluorosulfonyl)imide.

11. The battery cell of claim 9 wherein the solvent includes ethylene carbonate, ethyl methyl carbonate, and diethyl carbonate in a 25/45/30 volume ratio.

12. The battery cell of claim 9 wherein the electrolyte further includes 0.5 wt. % propylene sulfone.

13. The battery cell of claim 9 wherein the electrolyte further includes 0.3 wt. % 1,3-propene sultone.

14. The battery cell of claim 9 wherein the electrolyte further includes 0.5 wt. % ethylene sulfate.

15. The battery cell of claim 9 wherein the electrolyte further includes 1 wt. % lithium difluoro phosphate.

16. The battery cell of claim 9 wherein a capacity retention of the battery cell after 200 charge-discharge cycles is greater than 80%.

17. A battery cell comprising:
a negative electrode;
a positive electrode; and
an electrolyte, including 1M lithium hexafluorophosphate with a 1 wt. % of fluoroethylene carbonate and a 0.5 wt. % vinylene carbonate dissolved in a solvent of ethylene carbonate, ethyl methyl carbonate, and diethyl carbonate in a 25/45/30 volume ratio, saturating the negative and positive electrodes such that lithium ions liberated from the lithium hexafluorophosphate are stabilized by solvation with molecules of the vinylene carbonate resulting in a direct current impedance of the battery cell, for a given state of charge, being less than a direct current impedance of an otherwise same battery cell without the vinylene carbonate.

18. The battery cell of claim 17 wherein the direct current impedance is at least 10% less than the direct current impedance of the otherwise same battery cell without the vinylene carbonate.

19. The battery cell of claim 17 wherein the electrolyte further includes 0.5 wt. % propylene sulfone and 0.3 wt. % 1,3-propene sultone.

20. The battery cell of claim 17 wherein the electrolyte further includes 0.5 wt. % ethylene sulfate and 1 wt. % lithium difluoro phosphate.
